(19) United States
(12) Patent Application Publication
(10) Pub. No.: US 2012/0026512 A1
(43) Pub. Date: Feb. 2, 2012

(54) APPARATUS AND METHOD FOR DETERMINING SURFACE CHARACTERISTICS USING MULTIPLE MEASUREMENTS

(76) Inventor: Peter Schwarz, Koenigsdorf (DE)

(21) Appl. No.: 13/192,354

(22) Filed: Jul. 27, 2011

(30) Foreign Application Priority Data
Jul. 28, 2010 (DE) 10 2010 032 600.3

(51) Int. Cl. G01B 11/24

(52) U.S. Cl. 356/612

(57) ABSTRACT

An apparatus (1) for determining surface characteristics of measuring surfaces, comprising at least one first radiation device (2) that emits radiation onto a measuring surface (10), at least one first radiation detection device (4) that receives at least part of the radiation emitted by the at least one radiation device (2) and subsequently scattered from the measuring surface (10) and that outputs at least one measurement signal that is characteristic of the received radiation, and including a second radiation device (12) and a second radiation detection device (14) for carrying out gloss measurements on the measuring surface (10), wherein the second radiation device (12) radiates onto the measuring surface (10) at a specified angle of incidence (a) and the second radiation detection device (14) receives at least part of the radiation emitted by the at least second radiation device (2) and subsequently reflected from the measuring surface (10). According to the invention, the angle of incidence (a) formed relative to a direction (M) that is perpendicular to the measuring surface (10), at which the second radiation device (12) radiates onto the measuring surface, is no more than 50°.

The present invention relates to an apparatus and a method for determining surface characteristics. The invention is described with reference to the surfaces of motor vehicle paints, it is to be noted, however, that the apparatus according to the invention can also be used on other surfaces and in particular on high-gloss surfaces such as for example surfaces of pieces of furniture or of floors.

The optical appearance of articles or their surfaces, in particular of motor vehicles surfaces, is significantly influenced by their surface characteristics. Since the human eye is suitable for an objective evaluation of surface characteristics only to a limited extent, there is a need for tools and apparatus for the qualitative and quantitative determination of these surface characteristics.

In this respect, surface characteristics such as for example gloss, orange peel, colour, macro- and/or microstructure, image definition, reflection haze, surface structure and/or topography and the like are determined. Apparatus are known in the prior art wherein a radiation device emits radiation onto the measuring surface to be examined and the radiation reflected and/or scattered from this measuring surface is received and evaluated by a detector. DE 103 30 071 A1 describes such an apparatus and a method for examining surface characteristics. This document describes a radiation device which emits radiation onto the measuring surface, as well as a detector device which receives the light scattered from the surface. Further, means which cause the radiation to be directed onto the surface to be examined at a predefined angle are provided there. The subject matter of DE 103 30 071 A1 is herewith included in the subject matter of the present application in its entire scope.

Further, DE 103 30 071 A1 describes a further radiation device that directs light onto the surface as well as a detector device that receives the light reflected from the surface. This radiation device is here disposed at an angle relative to a direction that is perpendicular to the surface, and this angle is well above 45° and is in the order of 70°. Such an arrangement, however, is especially unsuitable for high-gloss surfaces such as in particular the coatings of motor vehicle paints, because in the case of this geometry of the viewing angle, the respective intensities incident on the detector change only very slightly as a function of a modification of the gloss characteristics. This will be explained in more detail below with reference to the figures. Thus, the apparatus described in DE 103 30 071 A1 is only to a limited extent suitable for gloss measurements on highly reflective or high-gloss surfaces.

The present invention is therefore based on the object of providing an apparatus and a method which is particularly suitable for carrying out measurements on highly reflective surfaces. According to the invention, this is achieved by means of an apparatus and a method according to the independent claims. Advantageous embodiments and developments are the subject matter of the dependent claims.

Colour measurements in the industry are, among other things, used for the examination of colour transitions in particular in the case of adjacent parts (such as for example the doors of motor vehicles). To this end, colour measurement devices with a 45° geometry or a spherical geometry (as described in international standards) are used. The colour measurement used in this case for a comparative measurement, however, is expedient only if the gloss value of both samples is identical or can at least be clearly and objectively compared. The reason is that the gloss value substantially influences the colour value that is determined from the above-mentioned measurement devices.

It is therefore a further object of the invention to take such correlations between the gloss characteristics and the colour characteristics into account, too.

An apparatus according to the invention for determining the surface characteristics includes a first radiation device that emits radiation onto a measuring surface. Apart from that, the apparatus includes at least one first radiation detection device that receives at least part of the radiation emitted by the at least one radiation device and subsequently scattered from the measuring surface and outputs at least one measurement signal that is characteristic of the received radiation or of at least one physical property of this radiation. Further, a second radiation device as well as a second radiation detection device are provided in order to carry out gloss measurements on the measuring surface.

The second radiation device radiates onto the measuring surface at a specified angle of incidence and the second radiation detection device receives at least part of the radiation emitted by the second radiation device and subsequently reflected from the measuring surface.

According to the invention, the angle of incidence formed relative to a direction that is perpendicular to the measuring surface, at which the second radiation device radiates onto the measuring surface, is no more than 50°, preferably no more than 30° and particularly preferably no more than 20°.

According to the invention, it is therefore proposed to combine a measurement of scattered radiation with a measurement of reflected radiation. In this way, it is particularly advantageously possible to examine gloss measurements with scatter light measurements (or colour measurements) on the same surface. In this connection, the first radiation device and the first radiation detection device are advantageously used for carrying out colour measurements. Advantageously, both radiation devices radiate here essentially onto the same area or geometrical location of the measuring surface to be examined. The combination of the two measurement variants as described here is particularly suitable for colour measurements. More specifically, colour and gloss measurements on highly reflective surfaces are here combined in order to obtain in this way an overall impression of the examined measuring surface. The term ‘gloss measurements’ is supposed to be understood in the context of this description to mean measurements carried out in reflection.

In the case of samples in which gloss and colour values may vary, a combination of colour and gloss measurements is therefore advantageous, in order to determine the optical or visual equality (or more generally, comparability) of two samples.

Apart from that, this first radiation detection device may also be suitable for detecting colours and/or colour structures and in particular surfaces or structures with inhomogeneous colours. In this way, the characteristics of effect pigments, such as for example the size or colour thereof, can be examined. In this respect, for example a CCD camera is suitable as a radiation detection device.

In order to allow a colour measurement to be carried out, for example LEDs of different wavelengths can be used on the transmission side, or filter arrays, optical grids or other polychromators can be used on the receiver side.

It would also be possible for the first radiation detection device and the second radiation detection device to coincide, i.e. that one radiation detection device fulfils the functions of both radiation detection devices. Advantageously, however, two different radiation detection devices which carry out the two measurements are used.

In a variant, the first detector device receives a locally resolved image of the scattered radiation. This means, a picture of the measuring surface is taken. However, it would also be possible and preferred if just the incident intensity of the incident radiation were determined. The second detector device may also be a detector device that measures only in an integrating manner, i.e. which determines an intensity of the radiation incident thereon.

However, it would also be possible that also the second detector device allows a locally resolved evaluation of the radiation incident thereon, in order to determine in this way a so-called goniometric curve which determines the radiation distribution around the reflection axis, for example at an angle of 5° to 10° about the reflection direction and preferably also in the reflection plane. For example, line array sensors could be used here.

Advantageously, also the second radiation detection device outputs at least one measurement signal which is characteristic of at least one physical property of the radiation incident thereon. Preferably, the second radiation detection device determines an intensity of the radiation incident thereon. Preferably, a spectral adjustment into the radiation path can be carried out here by means of optical filters, in order to simulate in this way the spectral curve of the sensitivity of the human eye.

Advantageously, the apparatus includes means for preventing that radiation of a second radiation device falls onto the first radiation detection device. These means may for example be a control device that causes the first radiation device and the second radiation device to radiate with a time delay and that also causes the respectively associated detector devices to detect with a corresponding time delay.

Advantageously, the first radiation detection device observes the surface relative to a perpendicular bisector at a very slight angle which is preferably less than 15°.

The arrangement according to the invention of the second radiation detection device at an angle of less than 50° is particularly suitable for examining surfaces which are highly reflective, such as for example the surfaces of motor vehicle paints.

Advantageously, the angle at which the second radiation device radiates is between 15° and 50°, particularly preferably between 15° and 40°, particularly preferably between 15° and 30° and is particularly preferably approx. 20°.

Advantageously, also the second radiation detection device emits a signal that is characteristic of the radiation incident thereon.

In a further advantageous embodiment, the apparatus has a third radiation device as well as a third radiation detection device for carrying out gloss measurements on the measuring surface, said third radiation device radiating at a specified second angle of incidence onto the measuring surface and said third radiation detection device receiving at least part of the radiation emitted by the third radiation device and subsequently reflected from the measuring surface. Advantageously, also the third radiation detection device emits at least one measurement signal that is characteristic of at least one physical property of the radiation incident thereon. Preferably, the third radiation detection device determines an intensity of the radiation incident thereon. However, it would also be possible here to carry out a locally resolved capturing of the radiation in order to carry out goniometric measurements.

Advantageously, the second angle of incidence formed relative to the direction that is perpendicular to the measuring surface, at which the third radiation direction radiates onto the measuring surface, is greater than 30°.

Advantageously, the second angle of incidence is greater than the first angle of incidence and is for example between 40° and 80°, preferably between 50° and 70° and particularly preferably between 55° and 65°. This second radiation device also allows, in a particularly advantageous manner, the examination also of more matt surfaces, as will be explained in more detail below. As a result of the combination of the three measurement devices, preferably an evaluation of the most varied surfaces to be examined becomes possible.

In a further advantageous embodiment, the apparatus includes a fourth radiation device and a fourth radiation detection device for carrying out gloss measurements on the measuring surface, said fourth radiation device radiating onto the measuring surface at a predetermined third angle of incidence and the fourth radiation detection device receiving at least part of the radiation emitted by the fourth radiation device and subsequently reflected from the measuring surface.

Advantageously, the third angle of incidence formed relative to the direction that is perpendicular to the measuring surface, at which the third radiation device radiates onto the measuring surface, is greater than 80°.

In this embodiment, a total of three radiation devices and three radiation detection devices are used for carrying out gloss measurements, and here the measurements to be carried out at different angles can advantageously be carried out independently from each other. Advantageously, the respective radiation devices can be controlled independently from each other.

It could be shown as a result of complex examinations that by using said three geometries for carrying out gloss measurements, meaningful information about the surface to be examined can be obtained. Also the selected angles are here advantageously suitable for obtaining comprehensive information about the surface to be examined.

In a further advantageous embodiment, an information output unit is provided which outputs a measurement value to the user, for the determination of which both measurement values of the first radiation detection device and measurement values of the second radiation detection device are used.

In a further advantageous embodiment, the apparatus includes an optical isolator device that is disposed (at least at times) on the optical path between the first radiation device and the first radiation detection device. By means of this optical isolator device it can be achieved that the light of the first radiation device is radiated onto the surface at a precisely defined angle. However, it would also be possible for the optical isolator device to be implemented such that a direct illumination of the surface to be examined by the radiation device is prevented.

Advantageously, the optical isolator device has at least one opening which extends, at least in sections, at a specified angle different from 0° relative to a thickness of the optical isolator device. For example, the optical isolator device can extend in a specified plane and the radiation enters this opening at an angle that is not vertical to this plane. Advantageously, this opening adheres to predefined apertures. For example, an all-around illumination at a predefined angle is possible, said angle being preferably between 20° and 70°, preferably between 30° and 60° and particularly preferably 45° relative to a direction that is perpendicular to the observed surface.

Thus, it is possible that the first radiation device generates radiation which then passes through said opening of the optical isolator device onto the measuring surface and from the measuring surface onto the first radiation detection device.

An optical isolator device is understood to be a device that is suitable for blocking optical radiation, in particular—but in particular not exclusively—light in the visible range or to prevent at least partially the transmission of this light onto a predetermined optical path. An opening that extends at least in sections at a specified angle different from 0° relative to the thickness of the isolator device is understood to mean an opening that extends not vertically to the surface of the isolator device but at an angle specified for this purpose. Preferably, this angle is between 30° and 60° and preferably 45° relative to a vertical that extends on the isolator device.

In a further advantageous embodiment, the first radiation device radiates into a first housing portion of the apparatus and an optical isolator device isolates this first housing portion from a second housing portion, with an opening being located in the second housing portion, through which the measuring surface can be observed by the first radiation detection device.

Here, radiation from the first housing portion can reach the second housing portion only via said openings. In a further advantageous embodiment, the first radiation detection device is disposed to be offset from a plane formed by the direction of incidence of the radiation emitted by the second radiation device and the reflection direction of the radiation reflected from the measuring surface.

Advantageously, the first radiation detection device is disposed relative to the plane at an angle between 5° and 20°, preferably between 5° and 15° and particularly preferably between 5° and 10°. By means of this arrangement, on the one hand a substantially vertical arrangement of the detection device may be achieved, on the other hand, however, any reflections of the radiation emitted by the first radiation device can be prevented from entering, in particular if an absorption device (also referred to as a light trap) for absorbing reflected radiation is additionally provided. Such an absorption device could, for example, be located opposite the radiation detection device with respect to this plane, so that it is ensured that no radiation is reflected from said opposite direction via the surface into the first radiation detection device. This embodiment is in particular suitable in the case of a diffuse illumination of the surface to be examined, which may be achieved for example by means of an implementation having a spherical geometry.

In a further advantageous embodiment, the first housing portion has the shape of a spherical segment. In this way, a particularly homogeneous generation of light is possible. Advantageously, an internal wall of the first housing portion is formed to reflect radiation (in particular diffuse) at least in sections. Advantageously, said internal wall is substantially completely formed so as to reflect radiation. In this way it can be achieved that the first radiation device illuminates the measuring surface indirectly (preferably at a plurality of angles of incidence). More specifically, the radiation sources of the first radiation device direct their radiation onto the internal wall of the first housing portion and from there the radiation is reflected multiple times until it ultimately reaches the measuring surface. Additionally, an optical isolator device can here be provided in the form of a shutter that prevents a direct illumination of the measuring surface by the first radiation device. Thus, the light is at least scattered or reflected here and the direction of radiation changes once or several times in particular on the radiation path between the first radiation device and the measuring surface.

In a further advantageous embodiment, also the second housing portion has the shape of a spherical segment at least in the area in which the opening for observing the measuring surface is located. Thus, the second housing portion could be implemented as a kind of Ulbricht sphere.

Advantageously, an internal wall of the second housing portion (in which the opening for observing the measuring surface is located) is implemented so as to reflect radiation at least in sections and preferably completely.

In a further advantageous embodiment, the apparatus includes a carrier for holding at least one detector device, and this carrier protrudes at least in sections into the first housing portion. In the case of DE 103 30 071 A1, the first detector device is mounted below the isolator device and therefore protrudes only into the second housing portion.

Advantageously it is proposed to displace the detector device significantly in the direction of the first housing portion. Advantageously the isolator device delimits the first housing portion. By disposing the detector device in the first housing portion, space is created in the second housing portion in order to accommodate therein also said second radiation device as well as said second detector device. Advantageously the carrier has a dome-shaped structure in which a detector device and preferably also an area of the second radiation device and of the second detector device are arranged.

In a further advantageous embodiment, the first radiation device illuminates the measuring surface indirectly. This means that light is initially scattered or reflected and in particular, as mentioned above, that the radiation direction is changed.

In a further advantageous embodiment, the first radiation device has a plurality of light sources. Particularly preferably, the light sources are light-emitting diodes (LEDs). It is possible here for a plurality of light-emitting diodes having different wavelength ranges or colours to be provided. Further, also white light-emitting diodes or filtered LEDs may be used. In a preferred embodiment, one or a plurality of light-emitting diodes of a first wavelength and one or a plurality of light-emitting diodes of a second wavelength are provided, with a control device being additionally provided that controls these different light-emitting diodes or light sources in a time sequence. In this way, the first radiation detection device may be used to receive a plurality of images, so that an evaluation via different colours may be carried out. In this way, an exact classification of the measuring surface becomes possible. However, it would also be possible to provide colour filter elements or filter wheels or the like in the optical path between the illumination means and the radiation receiver.

In a further advantageous embodiment, the apparatus includes a control device which controls the radiation devices as well as the radiation detection devices. Thus, the radiation devices are controlled such that they emit the radiation or the light preferably not continuously, but in a pulsed manner. Further, the control device causes the emission of light by the first radiation device to be carried out with a time delay in respect of the emission of light by the second radiation device. In this way it can be achieved that the two measurements will not distort each other. By means of this method, also the influence of ambient light can be determined and can be corrected in a suitable form. It is further possible for the apparatus to include an operating unit so that the user can select which radiation devices are to be activated.

Further, the control device also controls the respective radiation detection devices, so that the capturing of images or radiation can be triggered, for example, upon a corresponding light pulse that is emitted onto the surface. Preferably, the housing in its entirety has only one opening to the outside, namely the opening through which the surface is observed. In this way, the ingress of any external light into the housing can be prevented.

In a further advantageous embodiment, the device also includes a moving element in order to move the device relative to a measuring surface. In this way, for example wheels may be arranged on the device, which are particularly preferably coupled with a distance measurement device. Thus, the device is advantageously moved relative to an object to be examined during measurements. By means of this arrangement, also a path travelled relative to the measuring surface can be determined. However, it would also be possible for the device to be guided on a robot arm, and in this way a suitable position detection of the device relative to the object to be examined can be carried out.

The present invention is further directed to a method for particularly optically examining surfaces and in particular glossy surfaces. Here, radiation is emitted by a first radiation device onto a measuring surface, and by means of at least one first radiation detection device, at least part of the radiation emitted by the at least one radiation device and subsequently scattered from the measuring surface is received and at least one measurement signal that is characteristic of the received radiation is output.

Further, by means of a second radiation device, radiation is radiated onto the measuring surface at a specified angle of incidence, and the second radiation detection device receives at least part of the radiation emitted by the second radiation device and subsequently reflected from the measuring surface.

The scatter and reflection characteristics obtained in this way can be used to check during quality assurance whether a measurement object is within certain tolerances. The data may also be used to determine the formulation of a paint that corresponds to the surface of the measurement object. An example of this is the area of motor vehicle repair. In order to determine the corresponding paint formulation, the measurement values could be compared with a database in which a plurality of formulations is stored and could be selected and/or determined via the measured parameters. By means of this data, a paint can also be calculated by means of a paint formulation software.

According to the invention, the angle of incidence formed relative to a direction that is perpendicular to the measuring surface, at which angle of incidence the second radiation device radiates onto the measuring surface, is no more than 50°.

Therefore, it is proposed in respect of the method to carry out both a measurement of radiation scattered onto the measuring surface and a measurement of radiation reflected from the measuring surface. Preferably, the measurement results obtained from these two measurements are linked to each other. Advantageously, these measurements are carried out on the same section of the measuring surface.

Further advantages and embodiments will become evident from the attached drawings, wherein:

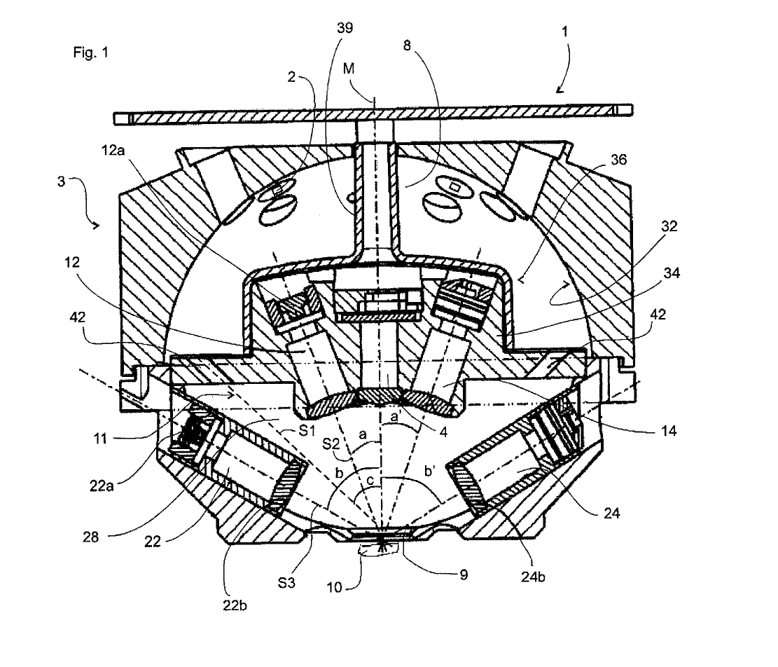

FIG. 1 shows a first embodiment of an apparatus according to the invention;

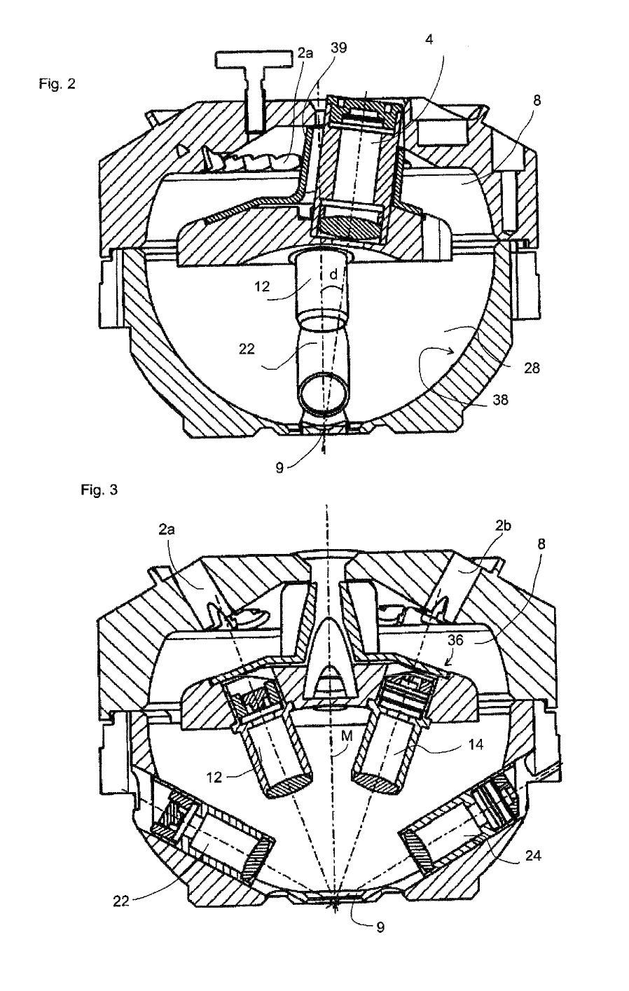

FIG. 2 shows a second embodiment of an apparatus according to the invention;

FIG. 3 shows a further view of the apparatus of FIG. 2;

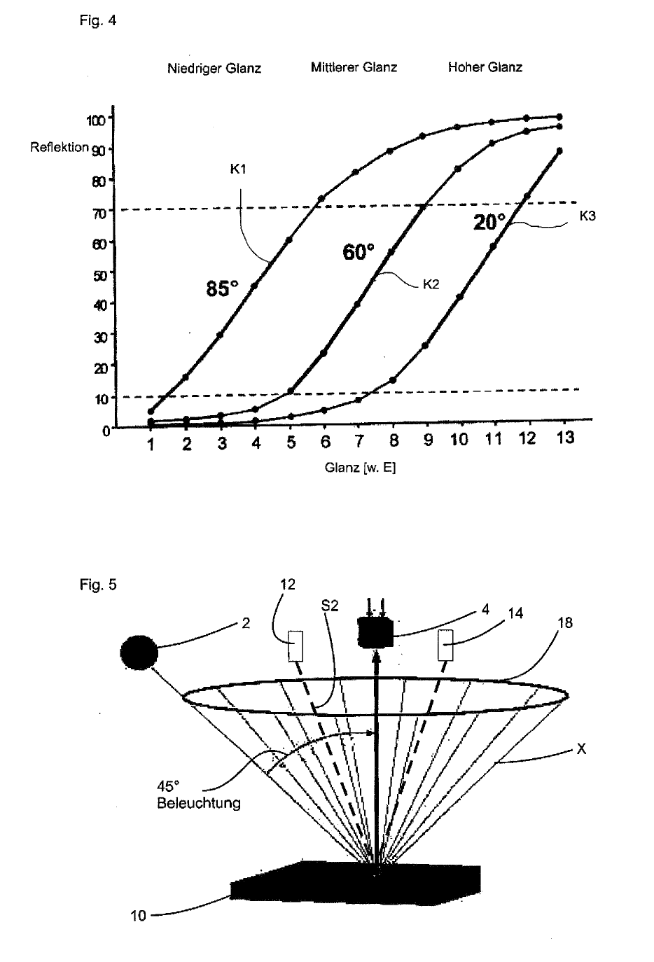

FIG. 4 shows a diagram for illustrating the underlying object of the invention; and

FIG. 5 shows a schematic view of a further embodiment according to the invention.

FIG. 1 shows a schematic view of a first embodiment of an apparatus 1 according to the invention. This apparatus 1 includes a housing 3 having a first housing portion 8 and a second housing portion 28. The housing portions 8 and 28 can be separated from each other. In the second housing portion 28, an opening 9 is provided, through which radiation can exit, so as to observe in this way a measuring surface 10 such as for example an area of a motor vehicle body.

In the first housing portion 8, a radiation device 2 (not shown in detail) is located, which has here a plurality of radiation sources that generate light within the first housing portion 8. This light is preferably reflected in the first housing portion 8 multiple times on the reflective internal walls 32 thereof and ultimately reaches the second housing portion 28 via an opening 42 that is preferably formed to be non-reflective and that is located in an isolator device 11. In this way it becomes possible to generate highly reflective and thus diffuse radiation that will still reach the measuring surface at a predetermined angle which is defined by the oblique position of the opening 42.

In the embodiment shown in FIG. 1, the opening 42 is inclined relative to a perpendicular bisector M at an angle of 45°, so that the radiation (S1) falls onto the measuring surface 10 at an angle of 45°. The opening 42 is here formed so as to be substantially circular, so that radiation or light (conically) falls onto the measuring surface 10 from all sides, but respectively at 45°. However, webs (not shown) may also be provided, which support the isolator device relative to the internal wall of the housing 3. The inside of the second housing portion is designed to absorb radiation.

The radiation scattered from the measuring surface 10 also passes in the direction of a detector device identified with 4, which captures here a locally resolved image of the measuring surface 10. This may here also be a photocell that integrates the scattered light. This detector device may include a CCD chip or similar for capturing locally resolved images.

Reference numeral 12 relates to a second radiation device which in turn directs radiation onto the measuring surface 10. Here, the radiation is radiated at an angle a between 10° and 30° and preferably in the order of 20°. The radiation reflected from the measuring surface is captured by a detector device 14, and in this way the gloss of the surface is determined. Especially in the case of highly reflective surfaces, the proportion of reflected radiation in the case of this measurement geometry changes to a comparatively great extent as a function of the gloss characteristics of the surface. The second radiation device may here include a light source 12a such as an LED that emits white light.

Reference numerals 12b and 14b in turn relate to lens devices used for imaging the reflected radiation. The detector device 14 can be implemented here for example as an intensity measurement device.

Reference numeral 22 identifies a third radiation device that also radiates onto the measuring surface 10 along the line S3. Here, the radiation is emitted at an angle B relative to the perpendicular bisector M that is between 40° and 90°, preferably between 50° and 90° and particularly preferably between 60° and 90°. Advantageously, an angle of incidence in the order of 60° is used.

A third radiation detection device 24, which also includes a lens 24b, detects the radiation reflected from the measuring surface 10. Thus, the third radiation detection device is disposed at a reflection angle b′ relative to the perpendicular bisector M. The angles b and b′ but also a and a′ are preferably substantially identical (or mirror-inverted).

It would also be conceivable to integrate a fourth measurement arrangement in order to measure extremely matt samples, which differs from the other gloss measurement arrangements by a very large angle of >70°, preferably between 80 and 90°.

FIG. 2 shows a further embodiment of the apparatus according to the invention, in which for the purpose of illustration the apparatus was turned by 90°. Here, too, the second radiation device 12 and the third radiation device 22 can be seen. What can also be seen is that in the first housing portion 8, a plurality of light sources 2a is provided, each of which illuminates the internal space of the housing portion 8. Reference numeral 38 relates to an internal wall of the second housing portion, which is here formed so as to reflect radiation. What can be seen is that the two radiation devices have been inserted very far into the inside of the second housing portion 28.

Here, too, the first radiation detection device 4 can be seen again. This radiation detection device is inclined by an angle d relative to a plane E, which is defined by the figure plane in FIG. 1. This angle d is in a range between 6° and 14°, preferably between 6° and 10° and is particularly preferably in the order of 8°. By means of this inclination it can be achieved that as little as possible radiation reflected from the surface (which comes from the second and third radiation devices or from the reflecting housing surface) enters into the first radiation detection device, but that the latter essentially receives instead only scattered radiation.

FIG. 3 shows the apparatus from FIG. 2 in a view rotated by 90°. It can be seen that the second radiation device 12 as well as the second radiation detection device 14 are mounted on a carrier 36 and extend partially into the first housing portion 1. By means of this upward displacement of the second radiation device and of the second radiation detection device it becomes possible to accommodate also the first radiation detection device in the housing. Reference sign M identifies a perpendicular bisector. The carrier can be disposed so as to be suspended from the first housing portion by a bracket 39.

Reference numerals 2a and 2b identify here light sources such as for example LEDs which are arranged in a wall of the first housing portion 8. In this embodiment, the individual LEDs 2a and 2b are arranged along a circle, in order to radiate in this way substantially from all sides into the first housing portion 8. Further, a control device (not shown) is provided, which controls the individual light sources 2a, 2b . . . so as to achieve in this way illumination within the first housing portion 8.

Also the second housing portion 28 is designed to have the shape of a substantially spherical segment in the area of the opening, as mentioned above.

FIG. 4 shows a graph for illustrating the individual reflectivities. Here, three graphs K1 to K3 are shown which are respectively associated with different measurement geometries of 85°, 60° and 20°. These angle details indicate, as in FIG. 1, the depicted incidence geometry of the individual second and third radiation devices. The X axis shows here arbitrary units with regard to the gloss characteristics of the surface. The Y axis shows the reflection or the reflectivity of the respective material. It can be seen that in the case of gloss modifications in the area with faint gloss, the reflection characteristics of poorly reflecting surfaces will initially change to a great extent and then later the curve will become flatter. In the case of geometries of 20°, the reflection characteristics change initially only slightly and later to an increasing extent. A mathematical description of this dependency of the reflectance on the angle of incidence, or the preference given to smaller angles of reflection in the case of high-gloss surfaces, is provided in the Fresnel formula.

Apart from that it would be conceivable for the housing to be designed to be spherical or in a shape similar to that of a sphere, and for at least one radiation device and preferably also one radiation detection device (which is preferably not arranged at the reflection angle with regard to the radiation device) to be integrated in the wall or to illuminate the spherical surface from the outside through the wall thereof. In this respect this radiation device, as well as the radiation detection device, are in particular used for carrying out colour measurements.

A direct illumination of the measuring surface is here advantageously avoided.

The second radiation device and the second radiation detection device for carrying out gloss measurements are here advantageously disposed respectively at an angle relative to the direction that is perpendicular to the measuring surface, that is less than 50°, and here, as in the embodiment example shown above, the angle of incidence and the angle of detection are substantially mirror-inverted.

The radiation devices and the radiation detection devices may here respectively be formed as tubes which are integrated into the wall of the (if necessary spherical) housing. These tubes may here be terminated to be flush with the internal surface of the housing wall, they may protrude inwards or they may also be offset towards the outside.

FIG. 5 shows a schematic view of a further apparatus according to the invention. Here again, a radiation device 2 is shown that radiates the light onto the measuring surface 10 at a specified angle, here 45°. In addition to or instead of the radiation device 2, also several radiation devices that illuminate the measuring surface at said angle (along the radiation directions X) or a radiation device 18 formed in a circumferential manner, which radiates the measuring surface in a circumferential manner at an angle of 45°, could be provided. The first radiation detection device 4 is here arranged at an angle of 90° relative to the surface to be examined.

In this connection, the internal surface of a corresponding housing could be designed so as to absorb radiation, or it could be ensured in particular in a different way that the illumination of the measuring surface is carried out exclusively at a certain angle, here 45°.

Here again, the second radiation device 12 as well as the second radiation detection device 14 are used for carrying out gloss measurements. The second radiation detection device is here arranged in such a way that it receives the light reflected from the measuring surface.

The applicant reserves the right to claim all of the features disclosed in the application documents as being essential to the invention in as far as they are novel over the prior art either individually or in combination.

### LIST OF REFERENCE NUMERALS

1 Apparatus
2 Radiation device
2a,b Light sources, LEDs
3 Housing
4 Detector device, radiation detection device
8 First housing portion
9 Opening
10 Measuring surface
11 Isolator device
12 Second radiation device
12a Light source
12b Lens device
14 Detector device, second radiation detection device
14b Lens device
18 Optional first radiation device
22 Third radiation device
24 Radiation detection device
24a Lens device
28 Second housing portion
32 Internal wall
36 Carrier
38 Internal wall of the second housing portion
39 Bracket
42 Opening
a Angle
a′ Reflection angle
b Angle
b′ Reflection angle
c Angle
d Angle
E Plane
K1-K3 Graphs
M Perpendicular bisector
S1-S3 Radiation direction
Radiation direction

X Further radiation direction

1. An apparatus for determining surface characteristics of measuring surfaces, comprising at least one first radiation device that emits radiation onto a measuring surface, at least one first radiation detection device that receives at least part of the radiation emitted by the at least one radiation device and subsequently scattered from the measuring surface and that outputs at least one measurement signal that is characteristic of the received radiation, including a second radiation device and a second radiation detection device for carrying out gloss measurements on the measuring surface, wherein the second radiation device radiates onto the measuring surface at a specified angle of incidence (a) and the second radiation detection device receives at least part of the radiation emitted by the at least second radiation device and subsequently reflected from the measuring surface,
wherein
the angle of incidence (a) formed relative to a direction (M) that is perpendicular to the measuring surface, at which the second radiation device radiates onto the measuring surface, is no more than 50°.

2. The apparatus as claimed in claim 1, wherein apparatus includes a third radiation device and a third radiation detection device for carrying out gloss measurements on the measuring surface, said third radiation device radiating onto the measuring surface at a specified second angle of incidence (b), and said third radiation detection device receiving at least part of the radiation emitted by the third radiation device and subsequently reflected from the measuring surface.

3. The apparatus as claimed in claim 2, wherein the second angle of incidence (b) formed in relation to a direction (R) that is perpendicular to the measuring surface, at which the second radiation device radiates onto the measuring surface, is at least 30°.

4. The apparatus as claimed in claim 1, wherein the apparatus includes a fourth radiation device and a fourth radiation detection device for carrying out gloss measurements on the measuring surface, said fourth radiation device radiating onto the measuring surface at a specified third angle of incidence, and said fourth radiation detection device receiving at least part of the radiation emitted from the fourth radiation device and subsequently reflected from the measuring surface.

5. The apparatus as claimed in claim 4, wherein the third angle of incidence (b) formed in relation to a direction (R) that is vertical to the measuring surface, at which the third radiation device radiates onto the measuring surface, is greater than 80°.

6. The apparatus as claimed in claim 1, wherein the apparatus includes an optical isolator device that is disposed on the optical path between the first radiation device and the first radiation detection device.

7. The apparatus as claimed in claim 6, wherein the first radiation device radiates into a first housing portion of the apparatus and the optical isolator device isolates this first housing portion from a second housing portion, said second housing portion having an opening located therein, through which the measuring surface can be observed by the first radiation detection device.

8. The apparatus as claimed in claim 1, wherein the first detection device is arranged to be offset relative to a plane (E) that is formed by the radiation direction (R1) of the radiation radiated by the second radiation device and the reflection direction (R2) of the radiation reflected from the measuring surface.

9. The apparatus as claimed in claim 7, wherein the first housing portion has the shape of a spherical segment.

10. The apparatus as claimed in claim 7, wherein an internal wall of the first housing portion is formed to reflect radiation at least in sections.

11. The apparatus as claimed in claim 7, wherein an internal wall of the second housing portion is formed so as to absorb radiation at least in sections.

12. The apparatus as claimed in claim 7, wherein an internal wall of the second housing portion is formed so as to reflect radiation at least in sections.

13. The apparatus as claimed in claim 7, wherein the apparatus includes a carrier for supporting at least one detector device and this carrier protrudes into the first housing portion.

14. The apparatus as claimed in claim 7, wherein the first radiation device indirectly illuminates the measuring surface.

15. A method for particularly optically examining measuring surfaces and in particular glossy measuring surfaces, wherein radiation is emitted onto a measuring surface by a first radiation device, and by means of at least a first radiation detection device, at least part of the radiation emitted by the at least one radiation device and subsequently scattered from the measuring surface is received and at least one measurement signal that is characteristic of the received radiation is output, and wherein further radiation is emitted by a second radiation device onto the measuring surface at a predetermined angle of incidence (a), and using a second radiation detection device, at least part of the radiation emitted by the second radiation device and subsequently reflected from the measuring surface is received,
wherein
the angle of incidence (a) formed in relation to the direction (M) that is perpendicular to the measuring surface, at which the second radiation device radiates onto the measuring surface, is no more than 50°.
